(19) United States
(12) Patent Application Publication
(10) Pub. No.: US 2022/0229716 A1
(43) Pub. Date: Jul. 21, 2022

(54) EVALUATION DEVICE, SYSTEM, CONTROL METHOD, AND PROGRAM

(71) Applicant: NEC Corporation, Minato-ku, Tokyo (JP)

(72) Inventors: Kazuhiko ISOYAMA, Tokyo (JP); Yashiaki SAKAE, Tokyo (JP); Jun NISHIOKA, Tokyo (JP)

(73) Assignee: NEC Corporation, Minato-ku, Tokyo (JP)

(21) Appl. No.: 17/614,677

(22) PCT Filed: May 30, 2019
(86) PCT No.: PCT/JP2019/021475

§ 371 Date: Nov. 29, 2021

(51) Int. Cl. G06F 11/07; G06F 11/30; G06F 8/61

(52) U.S. Cl. CPC G06F 11/0754; G06F 8/61; G06F 11/3003

(57) ABSTRACT

An evaluation apparatus (2000) acquires introduction-related information (30) for an application (10) in which an abnormality is detected. The introduction-related information (30) is information related to introduction of the application (10). The evaluation apparatus (2000) performs, by using the introduction-related information (30), an evaluation of the application (10) in which an abnormality is detected.

### TECHNICAL FIELD

The present invention relates to an evaluation of an application.

### BACKGROUND ART

A system for performing an evaluation of an application has been developed. For example, PTL 1 discloses a system for learning, in advance, a normal operation model when observation target software normally operates, and detecting an abnormality in monitoring target software by comparing an operation of the observation target software with the model.

### RELATED DOCUMENT

### Patent Document

[PTL 1] Japanese Patent Application Publication No. 2008-129714

[PTL 2] United States Patent Application Publication No. 2019/0050571 Description

### SUMMARY OF THE INVENTION

### Technical Problem

In a system for performing abnormality detection, based on an operation of an application, as in PTL 1, abnormality detection tends to be excessive for fear of an occurrence of detection failure (false negative). For example, the system is set in such a way as to handle, as abnormal behavior, behavior that is not certain whether the behavior is abnormal. Thus, behavior that is not actually abnormal is detected as abnormal behavior.

The present invention has been made in view of the problem described above, and one of objects of the present invention is to provide a technique for performing an evaluation of an application with higher accuracy.

### Solution to Problem

An evaluation apparatus according to the present invention includes 1) an acquisition unit that acquires, for an application on which processing of detecting an abnormality in an application is performed, introduction-related information related to introduction of the application, and 2) an evaluation unit that performs an evaluation of the application by using the acquired introduction-related information.

A system according to the present invention is a system including an abnormality detection apparatus and an evaluation apparatus.

The abnormality detection apparatus performs processing of detecting an abnormality in an application.

The evaluation apparatus includes 1) an acquisition unit that acquires, for an application on which processing of abnormality detection is performed by the abnormality detection apparatus, introduction-related information related to introduction of the application, and 2) an evaluation unit that performs an evaluation of the application by using the acquired introduction-related information.

A control method according to the present invention is executed by a computer. The control method includes 1) an acquisition step of acquiring, for an application on which processing of detecting an abnormality in an application is performed, introduction-related information related to introduction of the application, and 2) an evaluation step of performing an evaluation of the application by using the acquired introduction-related information.

### Advantageous Effects of Invention ADVANTAGEOUS EFFECTS OF INVENTION

The present invention provides a technique for performing an evaluation of an application with higher accuracy.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating an outline of an operation of an evaluation apparatus according to the present example embodiment.

FIG. 2 is a diagram illustrating a configuration of an evaluation apparatus according to an example embodiment 1.

FIG. 3 is a diagram illustrating a computer for achieving the evaluation apparatus.

FIG. 4 is a flowchart illustrating a flow of processing executed by the evaluation apparatus according to the example embodiment 1.

FIG. 5 is a diagram illustrating a usage environment of the evaluation apparatus according to the example embodiment 1.

FIG. 6 is a diagram illustrating introduction-related information in a table format.

FIG. 7 is a diagram illustrating reference information in a table format.

FIG. 8 is a block diagram illustrating a configuration of the evaluation apparatus including an output unit.

FIG. 9 is a diagram illustrating a configuration that manages the reference information.

FIG. 10 is a diagram illustrating an evaluation result screen.

FIG. 11 is a block diagram illustrating a functional configuration of an evaluation apparatus according to an example embodiment 2.

FIG. 12 is a flowchart illustrating a flow of processing executed by the evaluation apparatus according to the example embodiment 2.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted. Further, in each block diagram, each block represents a configuration of a functional unit instead of a configuration of a hardware unit unless otherwise described.

### Outline

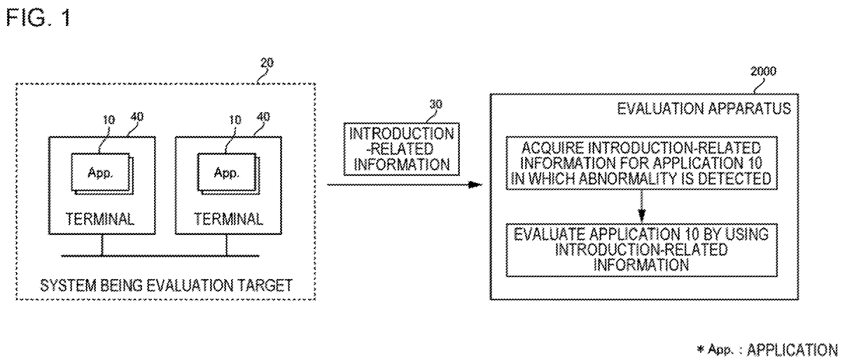

FIG. 1 is a diagram illustrating an outline of an operation of an evaluation apparatus 2000 according to the present example embodiment. FIG. 1 is a diagram representing schematic description for facilitating understanding of the operation of the evaluation apparatus 2000, and does not specifically limit the operation of the evaluation apparatus 2000.

The evaluation apparatus 2000 performs an evaluation of an application 10 in which an abnormality is detected. An abnormality in the application 10 is detected by an abnormality detection system for detecting an abnormality in the application 10, based on behavior of the application 10, for example. Note that, a technique for detecting an abnormality in an application, based on behavior of the application, in such a manner is referred to as an endpoint detection and response (EDR) and the like. However, a method of detecting an abnormality in the application 10 may be a method different from an evaluation by the evaluation apparatus 2000, and is not necessarily limited to the EDR.

The evaluation apparatus 2000 acquires introduction-related information 30 for the application 10 in which an abnormality is detected. The introduction-related information 30 is information related to introduction of the application 10 to an execution environment (such as an OS and middleware) in which the application 10 operates. For example, the introduction-related information 30 indicates an introduction path and the like of the application 10.

The evaluation apparatus 2000 performs, by using the introduction-related information 30, an evaluation of the application 10 in which an abnormality is detected. The evaluation of the application 10 is, for example, an evaluation whether the application 10 is an abnormal application. In other words, for the application 10 in which an abnormality is detected with some sort of reference such as behavior, whether the application 10 is abnormal is determined by further using information related to introduction of the application 10. In addition, for example, an evaluation of the application 10 may be an evaluation of an abnormality degree of the application 10. In other words, for the application 10 determined to be abnormal with reference to behavior and the like, an abnormality degree of the application 10 is computed based on information related to introduction of the application 10.

### One Example of Advantageous Effect

In an abnormality detection system achieved by an existing abnormality detection technique such as an EDR, abnormality detection tends to be excessive for fear of an occurrence of detection failure. For example, the abnormality detection system is set in such a way as to handle, as abnormal behavior, behavior that is not certain whether the behavior is abnormal. Thus, behavior that is not actually abnormal is detected as abnormal behavior. In this way, for example, there is a problem of a great working burden on an IT administrator who analyzes a result of abnormality detection.

In this regard, the evaluation apparatus 2000 according to the present example embodiment performs, based on information related to introduction of the application 10 such as an introduction path, an evaluation of the application 10 in which an abnormality is detected based on behavior and the like of the application 10. In this way, an evaluation of the application 10 can be performed with higher accuracy.

For example, the evaluation apparatus 2000 evaluates whether the application 10 in which an abnormality is detected is actually abnormal, and evaluates an abnormality degree of the application 10. In this way, for example, only the application 10 determined to be abnormal in an evaluation by the evaluation apparatus 2000 is set as a target of a check by an IT administrator, and thus a working burden on the IT administrator and the like can be greatly reduced.

Hereinafter, the evaluation apparatus 2000 according to the present example embodiment will be described in more detail.

### Example of Functional Configuration of Evaluation Apparatus 2000

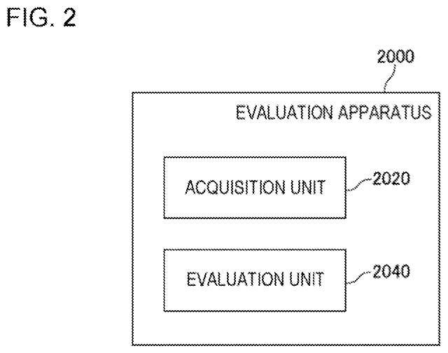

FIG. 2 is a diagram illustrating a configuration of an evaluation apparatus 2000 according to an example embodiment 1. The evaluation apparatus 2000 includes an acquisition unit 2020 and an evaluation unit 2040. The acquisition unit 2020 acquires the introduction-related information 30 for the application 10 in which an abnormality is detected. The evaluation unit 2040 performs, by using the introduction-related information 30, an evaluation of the application 10 in which an abnormality is detected.

### Hardware Configuration of Evaluation Apparatus 2000

Each functional component unit of the evaluation apparatus 2000 may be achieved by hardware (for example, a hard-wired electronic circuit, and the like) that achieves each functional component unit, and may be achieved by a combination of hardware and software (for example, a combination of an electronic circuit and a program that controls the electronic circuit, and the like). Hereinafter, a case where each functional component unit of the evaluation apparatus 2000 is achieved by the combination of hardware and software will be further described.

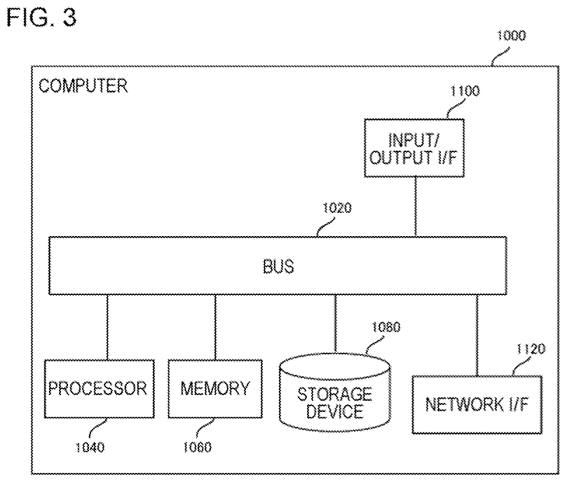

FIG. 3 is a diagram illustrating a computer 1000 for achieving the evaluation apparatus 2000. The computer 1000 is any computer. For example, the computer 1000 is a personal computer (PC), a server machine, a tablet terminal, a smartphone, or the like. The computer 1000 may be a dedicated computer designed for achieving the evaluation apparatus 2000, and may be a general-purpose computer.

The computer 1000 includes a bus 1020, a processor 1040, a memory 1060, a storage device 1080, an input/output interface 1100, and a network interface 1120. The bus 1020 is a data transmission path for allowing the processor 1040, the memory 1060, the storage device 1080, the input/output interface 1100, and the network interface 1120 to transmit and receive data with one another. However, a method of connecting the processor 1040 and the like to each other is not limited to bus connection. The processor 1040 is a processor such as a central processing unit (CPU), a graphics processing unit (GPU), or a field-programmable gate array (FPGA). The memory 1060 is a main storage apparatus achieved by using a random access memory (RAM) and the like. The storage device 1080 is an auxiliary storage apparatus achieved by using a hard disk drive, a solid state drive (SSD), a memory card, a read only memory (ROM), or the like. However, the storage device 1080 may be constituted by hardware similar to hardware constituting the main storage apparatus, such as the RAM.

The input/output interface 1100 is an interface for connecting the computer 1000 and an input/output device. The network interface 1120 is an interface for connecting the computer 1000 to a communication network. The communication network is, for example, a local area network (LAN) and a wide area network (WAN). A method of connection to the communication network by the network interface 1120 may be wireless connection or wired connection.

The storage device 1080 stores a program module that achieves each functional component unit of the evaluation apparatus 2000. The processor 1040 achieves a function associated with each program module by reading each of the program modules to the memory 1060 and executing the program module.

### Flow of Processing

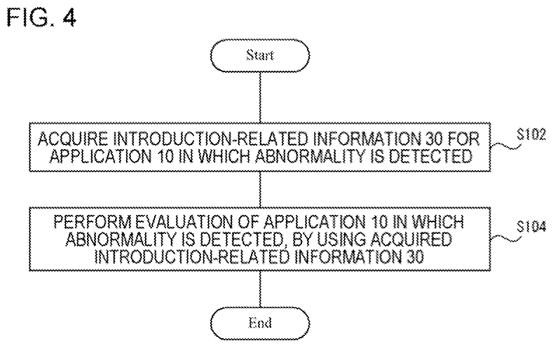

FIG. 4 is a flowchart illustrating a flow of processing executed by the evaluation apparatus 2000 according to the example embodiment 1. The acquisition unit 2020 acquires the introduction-related information 30 for the application 10 in which an abnormality is detected (S102). The evaluation unit 2040 performs, by using the introduction-related information 30, an evaluation of the application 10 (S104).

### Example of Usage Environment

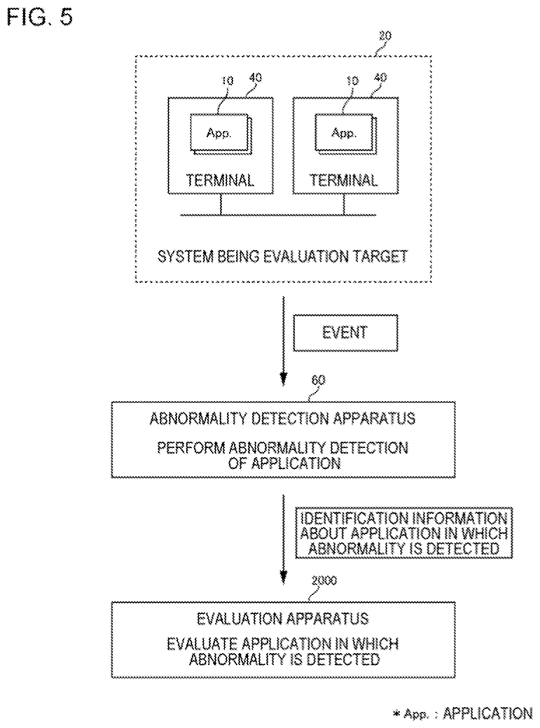

FIG. 5 is a diagram illustrating a usage environment of the evaluation apparatus 2000 according to the example embodiment 1. In FIG. 5, a target system 20 is a computer system including one or more terminals 40. The application 10 is introduced to each of the terminal 40. Note that, the application 10 being an application that may be a target of an evaluation by the evaluation apparatus 2000 may be all applications introduced to the target system 20, or may be a part of the applications.

An abnormality detection apparatus 60 detects an abnormality in the application 10. In the example in FIG. 5, the abnormality detection apparatus 60 detects an abnormality in the application 10, based on behavior of the application 10. Behavior of the application 10 handled as an abnormality is, for example, dangerous behavior viewed in terms of security. However, the behavior handled as an abnormality in the abnormality detection apparatus 60 is not limited to an abnormality viewed in terms of security, and various abnormalities can be handled.

In order to achieve abnormality detection based on behavior, the abnormality detection apparatus 60 collects, from the terminal 40, a history of events representing behavior of each of the applications 10 operating in the terminal 40. For example, the event is recorded in a unit of system call. In other words, behavior of the application 10 is represented by a history of system calls in which a process being an execution subject of the application 10 is a subject or an object. Herein, an existing technique can be used as a method of recording an event representing behavior of an application in a terminal and a method of collecting a history of recorded events.

The abnormality detection apparatus 60 performs abnormality detection on each of the applications 10 by using an event history. Then, when an abnormality is detected in any of the applications 10, identification information about the application 10 is transmitted to the evaluation apparatus 2000. The identification information about the application 10 is represented by, for example, a combination of “identification information (such as an IP address) about the terminal 40 to which the application 10 is introduced, and a name of the application 10”. Note that, instead of a name of the application 10, a name of an execution file of the application 10, a path of an execution file of the application 10, and the like may be used.

Abnormality detection for the application 10 can be achieved by determining whether a sequence (event sequence) of an event represented by an event history collected for each of the applications 10 represents an abnormal event sequence. For the determination, for example, a model that defines a normal event sequence is generated in advance for each of the applications 10. The abnormality detection apparatus 60 determines, for each of the applications 10, whether an event sequence represented by an event history collected for the application 10 deviates from the model described above. The abnormality detection apparatus 60 detects, as an abnormal application 10, the application 10 having a collected event sequence that deviates from the model. Note that, an existing technique can be used as a technique for generating a model of a normal event sequence and a technique for detecting, as an abnormal event sequence, an event sequence that deviates from a model of a normal event sequence.

As exemplified in the present example, there are various advantages of providing the evaluation apparatus 2000 in a rear stage of the abnormality detection apparatus 60. For example, it is assumed that the evaluation apparatus 2000 evaluates whether the application 10 is abnormal. In this case, by setting a system configuration in such a way that a manual check is performed on only the application 10 being also determined to be abnormal in an evaluation by the evaluation apparatus 2000, a working burden on an IT administrator and the like can be greatly reduced.

In addition, for example, it is assumed that the evaluation apparatus 2000 performs an evaluation of each of various pieces of information related to introduction of the application 10. Specifically, it is assumed that an evaluation related to an introduction source (for example, a Web site) of the application 10, an evaluation related to a downloader used for downloading the application 10, an evaluation related to an installer used for introducing the application 10, and the like are each performed, and a result thereof is output. An IT administrator can accurately perform determination whether the application 10 is abnormal and the like by using the evaluation result. Further, since an evaluation is performed exclusively for the application 10 in which an abnormality is detected by the abnormality detection apparatus 60, a burden on an IT administrator who refers to a result of the evaluation is reduced.

Note that, the abnormality detection apparatus 60 may be achieved by a computer separated from a computer that achieves the evaluation apparatus 2000, or may be achieved by the same computer as that for the evaluation apparatus 2000. In FIG. 5, the abnormality detection apparatus 60 and the evaluation apparatus 2000 are separately provided. When the abnormality detection apparatus 60 and the evaluation apparatus 2000 are separately provided, the abnormality detection apparatus 60 is achieved by various computers similarly to the evaluation apparatus 2000. A hardware configuration of the computer is represented in FIG. 3 similarly to the hardware configuration of the computer 1000 that achieves the evaluation apparatus 2000, for example.

### With Regard to Introduction-Related Information 30

The introduction-related information 30 is information related to introduction of the application 10 being performed on the terminal 40 in which the application 10 operates. Herein, the “introduction of the application 10 to the terminal 40” means that the application 10 is brought into a state executable in the terminal 40. Herein, when the application 10 is located outside the terminal 40, the introduction to the terminal 40 also includes processing of acquiring the application 10. Thus, for example, the introduction of the application 10 to the terminal 40 includes 1) processing of acquiring the application 10, 2) processing of arranging the acquired application 10 on a file system, 3) processing of performing setting related to the application 10, and the like.

The acquisition of the application 10 is, for example, processing of downloading the application 10 from a server that provides the application 10, and reading the application 10 from a storage apparatus that stores the application 10. The processing of arranging the application 10 on a file system is, for example, processing of storing, in a predetermined directory, an execution file and a setting file of the application 10. The processing of performing setting related to the application 10 is, for example, processing of writing setting data needed for execution of the application 10 to a registry, a setting file, and the like.

Note that, the processing of arranging an execution file of the application 10 in a predetermined directory and the processing of performing setting related to the application 10 may be automatically performed by executing an installer of the application 10, and may be manually performed by a user who performs introduction work of the application 10. Further, the processing of acquiring the application 10 may also be automatically performed. For p example, when a certain application X needs a separate application Y, there is a case where an installer of the application X automatically performs acquisition of the application Y.

The introduction-related information 30 indicates information related to introduction of the application 10 in association with identification information about the application 10. For example, as described above, the identification information about the application 10 can be represented by a combination of “identification information about the terminal 40 to which the application 10 is introduced, a name of the application 10, and the like”, and the like.

As information related to introduction of the application 10 being included in the introduction-related information 30, various pieces of information can be adopted. For example, the introduction-related information 30 may include information below.
1) Path information: information related to an introduction path of the application 10
2) Arrangement information: information related to a place where the application 10 is arranged
3) Setting information: information related to setting due to introduction of the application 10

For the various pieces of information described above, a detailed content thereof and a method of acquiring the pieces of information will be described below.

### 1) With Regard to Path Information

The path information includes information related to software, hardware, a service, and the like involved in introduction of the application 10. The software involved in introduction of the application 10 is, for example, a downloader used for downloading the application 10, and an installer used for installing the application 10. Further, when an installer and the like of the application 10 acquires a file being compressed, it can also be said that decompression software used for decompressing the compressed file is software involved in introduction of the application 10. The hardware involved in introduction of the application 10 is, for example, a storage apparatus that stores an installer, an execution file, and the like of the application 10, and the like. The service involved in introduction of the application 10 is, for example, a Web site that provides an installer and the like of the application 10, a proxy arranged between a provision source of the application 10 and the terminal 40, and the like.

For example, it is assumed that a file F being a compressed file of an installer I of an application X is provided in a server S. Then, it is assumed that the file F is downloaded from the server S by using a downloader D, the file F is decompressed by decompression software B, the installer I of the application X acquired by the decompression is executed, and the application X is thus introduced to the terminal 40. In this case, for example, path information about the application X indicates information of “server S, downloader D, decompression software B, and installer I”.

Generation of the path information can be achieved by using, for example, a history (information representing a subject, an object, and a content of an event) of various events that may be related to introduction of the application 10. An event that may be related to introduction of the application 10 is, for example, downloading of a file, decompression of a compressed file, execution of an installer, and the like. Herein, the history of the events is stored in advance in a storage apparatus. Note that, an existing technique can be used as a technique for recording a history of events. Further, the history of the events herein may be the same as or different from a history of events used by the abnormality detection apparatus 60.

Generation of the path information is performed by, for example, agent software that resides in the terminal 40. For example, the agent software detects an occurrence of a specific event (hereinafter, a key event) that may occur due to introduction of the application 10. For example, the key event is execution of an installer. Furthermore, the agent software determines another event related to a key event in response to detection of the key event. For example, when a key event is execution of an installer, the agent software extracts, from a history of events, an event being decompression of a compressed file including the installer and an event being downloading of the compressed file.

By the extraction of the event described above, an event sequence related to introduction of the application 10 that is “downloading of a compressed file including an installer -> decompression of the compressed file -> execution of the installer” can be extracted. Information about an introduction path can be generated from this event sequence. For example, based on an event of downloading a compressed file, determination of a provision source (such as a Web site) of an installer of the application 10 and determination of a downloader used for downloading can be performed. Further, based on an event being decompression of a compressed file including an installer, decompression software used for the decompression can be determined. Furthermore, based on an event being execution of an installer, the installer used for installing the application 10 can be determined. The path information is formed of the various pieces of determined information.

Note that, an event applied to a predetermined condition can be used as a key event. For example, a standard directory in which an application is arranged is determined in advance for each OS and each piece of middleware, and writing of a file to such a directory is considered to be an event having a high probability of being related to introduction of the application 10. Thus, for example, the agent software detects, as a key event, an event of writing a file to a standard directory in which an application needs to be arranged.

In addition, for example, introduction of an application is often accompanied by updating of a registry and a predetermined setting file (such as a file in which an environment variable is stored). Thus, for example, the agent software detects, as a key event, an event of writing to a registry and a predetermined setting file.

In addition, for example, introduction of an application is often performed by using a known installer (for example, a standard installer prepared in an OS). Thus, for example, the agent software detects, as a key event, an event representing execution of such a known installer (an event representing execution of a predetermined program).

Note that, a predetermined condition used for detection of a key event is stored in advance in a storage apparatus that can be accessed from the agent software.

### 2) With Regard to Arrangement Information

The arrangement information indicates information related to a place (such as a directory) where a file (such as an execution file, and a setting file) related to the application 10 is written, and the like.

For example, generation of the arrangement information is performed as follows. First, as a premise, a history of events of writing a file is recorded in advance. Then, the agent software described above generates the arrangement information by using the history of the events. For example, the agent software first detects an event of execution of an installer. Furthermore, the agent software determines an event of writing a file being performed by the installer. Then, the agent software generates the arrangement information indicating a place where the file is written in each of the determined events.

### 3) With Regard to Setting Information

A change is added to a registry and an existing setting file due to installation of the application 10, depending on the application 10. The setting information represents a change in setting being added due to introduction of the application 10 in such a manner.

For example, similarly to the arrangement information, the setting information is generated by using a history of events of writing a file. For example, the agent software first detects an event of execution of an installer. Furthermore, the agent software determines an event of writing to a registry and a predetermined setting file being performed by the installer. Then, the agent software generates the setting information indicating a combination of “identification information (such as a path) about a file on which writing is performed in an event, and a content of data written to the file” for each of the determined events.

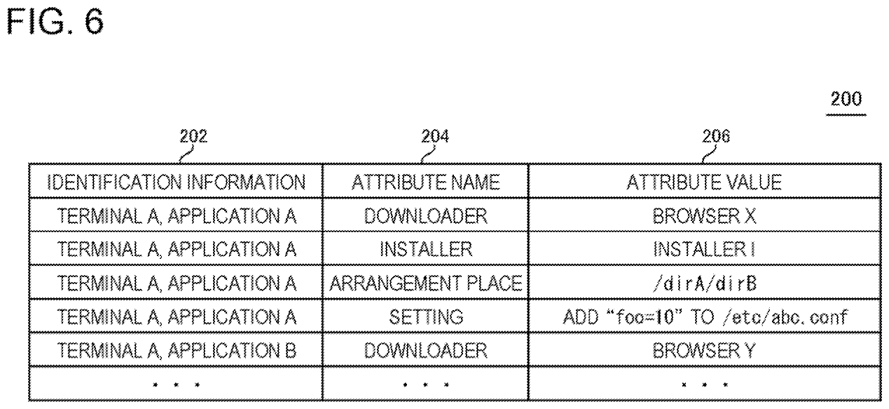

FIG. 6 is a diagram illustrating the introduction-related information 30 in a table format. The table illustrated in FIG. 6 is referred to as a table 200. The table 200 includes two columns of identification information 202, an attribute name 204, and an attribute value 206. The identification information 202 represents identification information about the application 10. The attribute name 204 represents a kind of information such as a provision source, a downloader, decompression software, an installer, arrangement information, and setting information. The attribute value 206 represents, for information about a kind indicated by the attribute name 202, a content of the information. For example, a record indicating a group of “identification information 202: application A of terminal X, attribute name 204: downloader, and attribute value 206: browser X” represents that the browser X is used as a downloader when the application A executed in the terminal X is introduced.

Note that, generation of the introduction-related information 30 does not necessarily need to be performed by the agent software described above. For example, generation of the introduction-related information 30 may be performed by the evaluation apparatus 2000. Specifically, when the evaluation apparatus 2000 acquires identification information about the application 10 in which an abnormality is detected, the evaluation apparatus 2000 extracts, by using the identification information, a history of events related to introduction of the application 10 from a history of events recorded for the terminal 40 in which the application 10 is executed. Then, the evaluation apparatus 2000 generates the introduction-related information 30 by using the extracted history of the events.

### Acquisition of Introduction-Related Information 30: S102

The acquisition unit 2020 acquires the introduction-related information 30 for the application 10 in which an abnormality is detected (S102). To do so, the acquisition unit 2020 acquires, from an apparatus (such as the abnormality detection apparatus 60 described above) that detects an abnormality in the application 10, identification information about the application 10 in which the abnormality is detected. Then, the acquisition unit 2020 acquires the introduction-related information 30 indicating the acquired identification information.

Any specific method of acquiring the introduction-related information 30 by the acquisition unit 2020 can be used. For example, the acquisition unit 2020 determines, by using identification information about the application 10 in which an abnormality is detected, the terminal 40 to which the application 10 is introduced. Then, the acquisition unit 2020 acquires, by communicating with agent software operating in the determined terminal 40, the introduction-related information 30 for the application 10 in which the abnormality is detected. For example, the acquisition unit 2020 transmits a request for acquisition of the introduction-related information 30 to the agent software. Identification information about the application 10 in which an abnormality is detected is included in this request. The agent software that receives the request transmits, to the acquisition unit 2020, the introduction-related information 30 for the application 10 whose identification information is indicated in the request.

Herein, the agent software may generate the introduction-related information 30 in response to reception of the request from the acquisition unit 2020, or may generate the introduction-related information 30 for each of the applications 10 in advance.

As described above, the introduction-related information 30 may be generated by the evaluation apparatus 2000. In this case, the acquisition unit 2020 acquires, by any method, the introduction-related information 30 generated by the evaluation apparatus 2000.

Note that, when the introduction-related information 30 is generated in advance, the introduction-related information 30 may be stored in advance in a storage apparatus that can be accessed from the evaluation apparatus 2000. In this case, the acquisition unit 2020 acquires, by accessing the storage apparatus, the introduction-related information 30 for the application 10 in which an abnormality is detected.

### Evaluation of Application 10: S104

The evaluation unit 2040 performs, by using the introduction-related information 30, an evaluation of the application 10 in which an abnormality is detected. For example, the evaluation unit 2040 performs an evaluation of the application 10 in which an abnormality is detected, by comparing the introduction-related information 30 acquired for the application 10 with information (hereinafter, reference information) being a reference of introduction of an application. The reference information can also be referred to as a rule, a policy, and the like.

### With Regard to Reference Information

For example, the reference information is information that determines an introduction path and the like for a normal application. With such reference information being used, for example, when a degree of coincidence between the introduction-related information 30 and the reference information is high, it can be determined that a normality degree of the application 10 is high. Such reference information is referred to as normal reference information.

For example, the normal reference information includes information below.
1) Normal path information: a normal introduction path of the application 10
2) Normal arrangement information: a normal arrangement place of the application 10
3) Normal setting information: normal setting due to installation of the application 10

The normal path information represents information about normal software, normal hardware, a normal service, and the like that are related to introduction of the application 10. For example, the normal path information represents a normal service and hardware (such as a Web site and a storage apparatus) being a provision source of the application 10. Furthermore, for example, the normal path information indicates normal software that may be used for introduction of an application, such as a normal installer, normal decompression software, and a normal downloader. The normal reference information is determined for each application, for example. In addition, for example, the normal reference information may be determined for each execution environment such as an OS.

Further, the normal path information may represent a set of a normal provision source and software. For example, the information is information that is “server S1, downloader D1, and installer I1”, and the like.

The normal arrangement information indicates a normal place (such as a directory) where an application needs to be installed. Note that, a place where an application needs to be installed may be determined for each application and each execution environment such as an OS.

The normal setting information represents normal setting performed due to introduction of an application. The normal setting information is determined for each application, for example. For example, it is assumed to be clear that a predetermined record R is added to a registry when an application X is introduced. In this case, the normal setting information for the application X indicates “addition of record R to registry”.

The reference information may be information that determines an introduction path and the like for an abnormal application. With such reference information being used, for example, when a degree of coincidence between the introduction-related information 30 and the reference information is high, it can be determined that an abnormality degree of the application 10 is high (a normality degree is low). Such reference information is referred to as abnormal reference information.

For example, the abnormal reference information may include information below.
1) Abnormal path information: an abnormal introduction path of an application
2) Abnormal arrangement information: an abnormal arrangement place of an application
3) Abnormal setting information: abnormal setting accompanying installation of an application

Details of the abnormal reference information can be basically recognized by replacing “normal” with “abnormal” in the description of the normal reference information. For example, the normal path information indicates normal software and the like that may be used for introduction of an application, whereas the abnormal path information indicates abnormal software and the like that may be used for introduction of an application. For example, when there is a known malicious Web site being known to spread malware, an URL and the like of the Web site can be included, in the abnormal path information, as a provision source of abnormal software.

Herein, instead of dividing the reference information into normal and abnormal, a normality degree (or an abnormality degree) of each attribute value may be indicated in the reference information in association with the attribute value. For example, information such as “attribute name: installer, attribute value: installer I1, and normality degree: c1” can be used as the reference information.

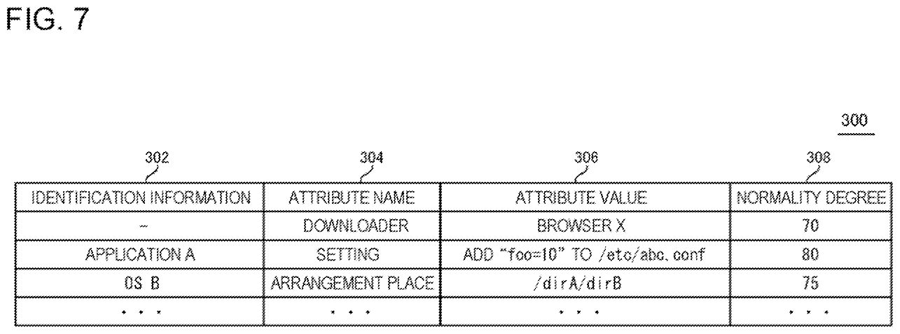

FIG. 7 is a diagram illustrating reference information in a table format. This table is referred to as a table 300. The table 300 includes four columns of identification information 302, an attribute name 304, an attribute value 306, and a normality degree 308. The identification information 302, the attribute name 304, and the attribute value 306 are similar to the identification information 202, the attribute name 204, and the attribute value 306 in the table 200. However, a record whose data are not indicated in the identification information 202 represents that the record does not depend on an application or an execution environment. The normality degree 308 represents a normality degree of an associated attribute value.

### Method of Evaluation

The evaluation unit 2040 performs an evaluation of the application 10 by comparing the introduction-related information 30 with the reference information. For example, the evaluation unit 2040 computes an evaluation value representing a normality degree or an abnormality degree of the application 10 by comparing the introduction-related information 30 with the reference information. Specifically, the evaluation unit 2040 computes an evaluation value, based on a degree of coincidence between the introduction-related information 30 and the reference information. Herein, various existing techniques can be used as a technique itself for computing a degree of coincidence between a rule or a policy (the reference information in the present invention) and an actual situation (the introduction-related information 30 in the present invention).

For example, a degree of coincidence between the introduction-related information 30 and the reference information can be computed by using an equation (1) below and the like.

$$\begin{matrix}[ Mathematical 1 ] & \\ v = \frac{\vert S \vert}{\vert E \vert} & ( 1 )\end{matrix}$$

Herein, v represents an evaluation value. E is a set of attribute values indicated in the introduction-related information 30, and |E| represents an element number of the set. Further, S is a set of attribute values in which the introduction-related information 30 and the reference information coincide with each other, and |S| represents an element number of the set.

When the introduction-related information 30 and the normal reference information are compared with each other, a degree of coincidence between them represents a normality degree of the application 10. On the other hand, when the introduction-related information 30 and the abnormal reference information are compared with each other, a degree of coincidence between them represents an abnormality degree of the application 10.

Further, it is assumed that the reference information indicates, for each attribute, a normality degree of the attribute. In this case, an integrated value and a statistic (such as an average value, a median, a mode, a maximum value, and a minimum value) of a normality degree of an attribute value that coincides between the introduction-related information 30 and the normal reference information can be used as an evaluation value representing a normality degree of the application 10. For example, an evaluation value can be computed by using an equation (2) below and the like.

$$\begin{matrix}[ Mathematical 2 ] & \\ v = \frac{{\sum }_{i ∈ S} {w}_{i}}{{\sum }_{j ∈ S} {w}_{j}} & ( 2 )\end{matrix}$$

Herein, wi is a normality degree provided to an attribute value i.

On the other hand, it is assumed that the reference information indicates, for each attribute, an abnormality degree of the attribute. In this case, an integrated value and a statistic of an abnormality degree of an attribute value that coincides between the introduction-related information 30 and the abnormal reference information can be used as an evaluation value representing an abnormality degree of the application 10. The computing method is similar to that for an evaluation value representing a normality degree.

Note that, the evaluation unit 2040 may use, for an evaluation, a degree of non-coincidence between the introduction-related information 30 and the reference information. For example, the evaluation unit 2040 computes an evaluation value representing a normality degree of the application 10 by subtracting an evaluation value representing a degree of non-coincidence between the introduction-related information 30 and the normal reference information from an evaluation value representing a degree of coincidence between the introduction-related information 30 and the normal reference information. Similarly, for example, the evaluation unit 2040 may compute an evaluation value representing an abnormality degree of the application 10 by subtracting an evaluation value representing a degree of non-coincidence between the introduction-related information 30 and the abnormal reference information from an evaluation value representing a degree of coincidence between the introduction-related information 30 and the abnormal reference information.

The evaluation unit 2040 may handle, as an evaluation result of the application 10, an evaluation value itself computed by a comparison between the reference information and the introduction-related information 30, or may perform predetermined determination, based on an evaluation value, and set the determination result as an evaluation result of the application 10. In a latter case, the evaluation value is assumed to represent a normality degree of the application 10. In this case, for example, the evaluation unit 2040 determines that the “application 10 is normal” when the evaluation value is equal to or more than a predetermined threshold value, and determines that the “application 10 is not normal” when the evaluation value is less than the predetermined threshold value. On the other hand, the evaluation value is assumed to represent an abnormality degree of the application 10. In this case, the evaluation unit 2040 determines that the “application 10 is abnormal” when the evaluation value is equal to or more than a predetermined threshold value, and determines that the “application 10 is not abnormal” when the evaluation value is less than the predetermined threshold value.

An evaluation of the application 10 is not limited to using an evaluation value. For example, the evaluation unit 2040 may determine a feature of the application 10 by comparing the introduction-related information 30 with the reference information, and set the feature as an evaluation result. For example, a feature of the application 10 is a determination result of whether each attribute value indicated by the introduction-related information 30 is normal. For example, when the introduction-related information 30 indicates path information, determination whether a provision source and software related to introduction of the application 10 are normal is performed, such as “provision source: normal, downloader: normal, decompression software: normal, installer: not normal”.

Determination whether each attribute value is normal is performed by a comparison between the introduction-related information 30 and the reference information. For example, an attribute value indicated by the introduction-related information 30 is determined to be normal when the attribute value and an attribute value indicated by the normal reference information coincide with each other, when the attribute value and an attribute value indicated by the abnormal reference information do not coincide with each other, when a normality degree of the attribute value indicated by the reference information is equal to or more than a predetermined threshold value, when an abnormality degree of the attribute value indicated by the reference information is less than the predetermined threshold value, or the like. On the other hand, an attribute value indicated by the introduction-related information 30 is determined to be not normal when the attribute value and an attribute value indicated by the normal reference information do not coincide with each other, when the attribute value and an attribute value indicated by the abnormal reference information coincide with each other, when a normality degree of the attribute value indicated by the reference information is less than a predetermined threshold value, when an abnormality degree of the attribute value indicated by the reference information is equal to or more than the predetermined threshold value, or the like.

Further, when the reference information indicating a normality degree or an abnormality degree is used, the evaluation unit 2040 may determine a normality degree or an abnormality degree of each attribute value of the introduction-related information 30 by comparing the introduction-related information 30 with the reference information. For example, when the introduction-related information 30 indicates path information, a normality degree of a provision source and software related to introduction of the application 10 is determined, such as “normality degree of provision source: c1, normality degree of downloader: c2, normality degree of decompression software: c3, normality degree of installer: c4”. As a normality degree of an attribute value indicated by the introduction-related information 30, a normality degree of the attribute value indicated by the reference information can be used. The same applies to an abnormality degree.

Note that, PTL 2 discloses a technique for evaluating safety of an application, based on information of an installer and the like. However, PTL 2 does not disclose at least an evaluation being performed on, as a target, an application in which an abnormality is detected by another abnormality detection method such as the EDR.

### Method of Generating Reference Information

There are various methods of generating the reference information described above. For example, the reference information is manually generated by an IT administrator and the like in an organization operating the evaluation apparatus 2000. In addition, for example, the reference information may be automatically generated by the evaluation apparatus 2000 or another apparatus. In order to facilitate description, it is assumed that the evaluation apparatus 2000 generates the reference information in the following description.

For example, the evaluation apparatus 2000 generates the reference information, based on performance of introduction of the application 10 in the target system 20. Conceptually, in introduction of an application up to this time in the terminal 40 included in the target system 20, an introduction path, an arrangement place, and setting that are more frequently used are each handled as an introduction path, an arrangement place, and setting that have a higher normality degree. For example, for each of the applications 10, the introduction-related information 30 is generated in advance at a timing at which the application 10 is introduced, and the like. Then, the evaluation apparatus 2000 generates the reference information by performing statistical processing on the introduction-related information 30 that has been generated up to this time.

For example, a normality degree of each attribute value is determined in such a way as to have a positive correlation with the number of pieces of the introduction-related information 30 that have been generated up to this time and indicate the attribute value. For example, a normality degree is determined as a value acquired by inputting the number described above to a predetermined non-monotone decreasing function. However, the number of the terminals 40 may be counted instead of the number of pieces of the introduction-related information 30. In other words, a normality degree of an attribute value is determined in such a way as to have a positive correlation with the number of the terminals 40 in which the introduction-related information 30 indicating the attribute value is generated.

When the reference information indicating a normality degree is generated, for example, the evaluation apparatus 2000 generates, for an attribute value having a normality degree being computed by the method described above, the reference information including a combination of the attribute value and the normality degree. When the normal reference information is generated, for example, the evaluation apparatus 2000 generates the normal reference information including an attribute value whose normality degree computed by the method described above is equal to or more than a predetermined threshold value. When the abnormal reference information is generated, for example, the evaluation apparatus 2000 generates the normal reference information including an attribute value whose normality degree computed by the method described above is equal to or less than a predetermined threshold value. Note that, a threshold value used for generation of the normal reference information and a threshold value used for generation of the abnormal reference information may be the same or be different.

Further, the evaluation apparatus 2000 may determine a normality degree and the like of each attribute value, based on a reputation in a group, an external organization, and the like in which the target system 20 is operated. A reputation in a group in which the target system 20 is operated can be acquired by, for example, collecting a questionnaire conducted on a member of the group, and collecting information posted on a social networking service (SNS) being operated in the group. Further, a reputation in an external group can be collected by, for example, accessing a site that opens information related to malicious software, such as malware, and a malicious Web site. The evaluation apparatus 2000 collects, by the methods, information about a reputation of various attribute values (such as a service and hardware that are a provision source of an application, software used for introduction, an arrangement place of an application, and setting performed by introduction of an application) that may be included in the reference information. Then, the evaluation apparatus 2000 performs, based on the collected information about the reputation, processing of computing a normality degree or an abnormality degree of each attribute value, and processing of determining whether each attribute value is normal or abnormal. Then, the evaluation apparatus 2000 generates the reference information, based on the processing results.

Further, when the application 10 is a famous application having high reliability, information about an introduction path and an arrangement place of the application, and setting performed due to introduction of the application may be open on a reliable Web site (for example, a Web site being a provision source of the application 10), and the like. Thus, the evaluation apparatus 2000 may generate the reference information by acquiring information by accessing a Web site and the like considered to provide highly reliable information about introduction of the application 10.

There are various methods of acquiring the reference information by the evaluation unit 2040. For example, the evaluation unit 2040 acquires the reference information from a storage apparatus that stores the reference information. In addition, for example, the evaluation unit 2040 may acquire the reference information from an apparatus that generates the reference information.

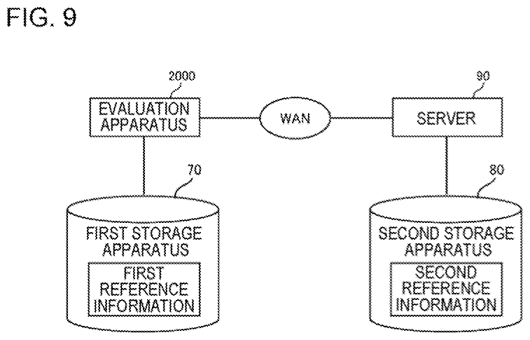

In addition, for example, the evaluation unit 2040 may acquire the reference information by a method described below. FIG. 9 is a diagram illustrating a configuration that manages the reference information. First, it is assumed that, as a storage apparatus that may store the reference information, a first storage apparatus 70 that requires a relatively short time for access from the evaluation unit 2040 and a second storage apparatus 80 that requires a relatively long time for access from the evaluation unit 2040 are provided. For example, the first storage apparatus 70 is a storage apparatus provided inside the evaluation apparatus 2000, or a storage apparatus connected to the evaluation apparatus 2000 with a LAN. Meanwhile, the second storage apparatus 80 is a storage apparatus (for example, a cloud storage) connected to the evaluation apparatus 2000 with a WAN.

The reference information may be stored in both of the first storage apparatus 70 and the second storage apparatus 80. Hereinafter, the reference information stored in the first storage apparatus 70 is referred to as first reference information, and the reference information stored in the second storage apparatus 80 is referred to as second reference information. The first reference information at a time of an operation start of the evaluation apparatus 2000 is manually generated by an IT administrator, for example. Further, the evaluation apparatus 2000 may update the first reference information, based on performance of introduction of the application 10 in the target system 20. The second reference information is updated any time by collecting information on the Internet by a server 90.

When the evaluation unit 2040 acquires the reference information used for a comparison with the acquired introduction-related information 30, the evaluation unit 2040 attempts to acquire the first reference information by first accessing the first storage apparatus 70. When an attribute value that coincides with an attribute value indicated by the introduction-related information 30 is included in the first reference information, the evaluation unit 2040 uses the first reference information. On the other hand, when there is, in an attribute value indicated by the introduction-related information 30, a coinciding attribute value that is not present in the first reference information, the evaluation unit 2040 accesses the server 90.

Specifically, the evaluation unit 2040 transmits a request indicating an attribute value to the server 90. The server 90 accesses the second storage apparatus 80, and determines whether the attribute value indicated by the request is included in the second reference information. When the attribute value indicated by the request is included in the second reference information, the server 90 transmits, to the evaluation unit 2040, a response including a record of the second reference information indicating the attribute value. The evaluation unit 2040 uses information included in the received record for an evaluation of the application 10. Further, the evaluation unit 2040 adds the record acquired in such a manner to the first reference information. In this way, the same information can be acquired from the first storage apparatus 70 instead of the second storage apparatus 80 in next and subsequent evaluations, and thus acquisition of the information can be more quickly performed. On the other hand, when the attribute value indicated by the request is not included in the second reference information, the server 90 transmits, to the evaluation unit 2040, a response indicating that desired information is not included in the second reference information. There are various methods for an evaluation performed by the evaluation unit 2040 in this case.

### Evaluation Further Using Information Other Than Introduction-Related Information 30

Information other than the introduction-related information 30 may be further used for an evaluation of the application 10. As the information other than the introduction-related information 30, for example, information below can be used.
1) Information related to a creator of the application 10
2) A signature (such as a hash value of binary) of the application 10
3) A reputation related to the application 10 itself

When a creator of the application 10 is a famous person or a famous organization, a normality degree of the application 10 is considered to be high. Further, when a signature of the application 10 coincides with a signature opened for an application that guarantees reliability (that is already authenticated by a legal certification authority, for example), a normality degree of the application 10 is considered to be high. Similarly, when a signature of the application 10 introduced to the terminal 40 coincides with a known signature of malware, a normality degree of the application 10 is considered to be low. Furthermore, when a reputation of the application 10 is high in a group, an external organization, and the like (for example, on the Internet) in which the target system 20 is operated, a normality degree of the application 10 is considered to be high.

In this way, various pieces of information other than information related to introduction of the application 10 may also be useful when an evaluation of the application 10 is performed. Thus, the evaluation apparatus 2000 may perform an evaluation of the application 10 by further using the various pieces of information. In this case, for example, in addition to a reference related to introduction of the application 10, a reference related to a creator, a signature, a reputation, and the like of the application 10 are also added to the reference information described above. For example, the reference is a reference such as “attribute name: creator, and attribute value: xyz.inc”. Further, the acquisition unit 2020 also acquires, for the application 10 in which an abnormality is detected, information related to a creator, a signature, a reputation, and the like of the application 10 in addition to the introduction-related information 30. Then, the evaluation unit 2040 performs an evaluation of the application 10 by comparing the various pieces of acquired information with the reference information.

A method of comparing information related to a creator, a signature, a reputation, and the like being acquired for the application 10 in which an abnormality is detected with the pieces of information included in the reference information is similar to a method of comparing the introduction-related information 30 with the reference information. For example, the evaluation unit 2040 includes, in a computation equation of an evaluation value exemplified by the equations (1) and (2) described above, not only a degree of coincidence of information related to introduction of the application 10, but also a degree of coincidence of a creator, a signature, a reputation, and the like.

### Output of Evaluation Result

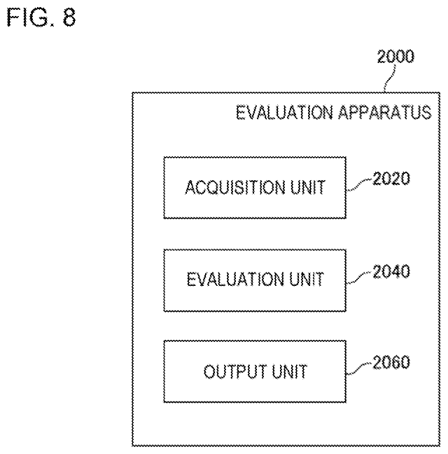

For example, the evaluation apparatus 2000 generates output information representing an evaluation result by the evaluation unit 2040, and performs outputting of the generated output information. A functional configuration unit that performs generation and outputting of the output information is referred to as an output unit 2060. FIG. 8 is a block diagram illustrating a configuration of the evaluation apparatus 2000 including the output unit.

The output unit 2060 generates the output information, based on an evaluation result by the evaluation unit 2040. For example, the output information includes a screen (hereinafter, an evaluation result screen) representing an evaluation result. The evaluation result screen includes, for example, information associated with identification information about each of the applications 10 on which an evaluation by the evaluation apparatus 2000 is performed (i.e., in which an abnormality is detected by the abnormality detection apparatus 60 and the like) and an evaluation result of the application 10.

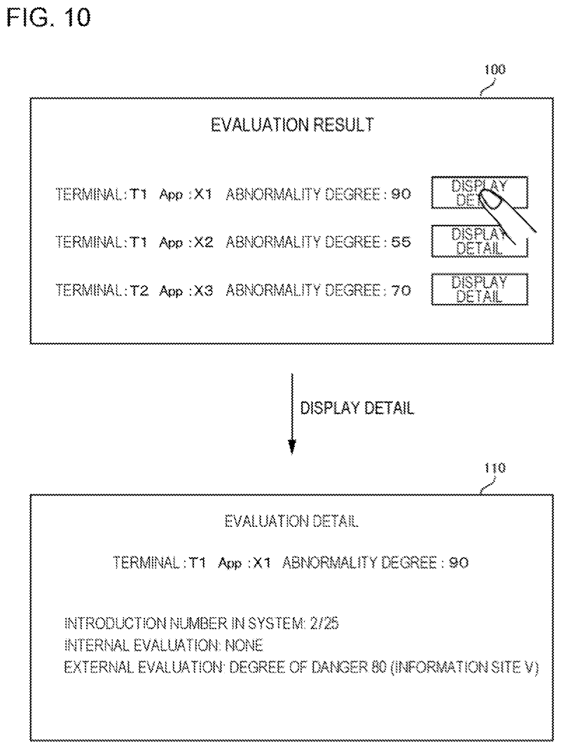

FIG. 10 is a diagram illustrating an evaluation result screen. In FIG. 10, an evaluation result screen 100 indicates, for each of the applications 10, identification information about the terminal 40 to which the application 10 is introduced, a name of the application 10, and an overall evaluation result of the application 10. The overall evaluation result indicates whether the application 10 is normal. Further, a button being “display detail” is provided for each of the applications 10. When the button is pressed, the output unit 2060 further outputs a detailed screen 110 indicating, for the application 10 associated with the button, information about an attribute value used for an evaluation of the application 10 and the evaluation.

Note that, the output information is not limited to a screen. For example, the output information may be a file in which an evaluation result of each of the application 10 in which an abnormality is detected is recorded. In this case, the output unit 2060 may record an evaluation of each of the applications 10 in one file or an individual file. Note that, the file described above may be stored in a storage apparatus that can be accessed from the evaluation apparatus 2000, or may be transmitted to another apparatus (for example, a terminal used by each IT administrator).

Further, a method of using an evaluation result by the evaluation unit 2040 is not limited to outputting of information representing the result. For example, as described in an example embodiment 2 below, an evaluation result by the evaluation unit 2040 may be used for control on the evaluated application 10, and the like.

The output unit 2060 may perform outputting of information to a user of the application 10 in which an abnormality is detected (a user of the terminal 40 in which the application 10 operates). For example, when the output unit 2060 is notified, from the abnormality detection apparatus 60, of detection of an abnormality in the application 10, the output unit 2060 starts by the evaluation unit 2040 for the application 10, and also transmits, to the terminal 40 in which the application 10 operates, notification representing that the abnormality is detected in the application 10 and an evaluation of the application 10 is being performed. For example, the notification is displayed on a display apparatus connected to the terminal 40. By viewing the notification, a user of the application 10 can recognize that the abnormality is detected in the application 10 and the evaluation of the application 10 is being performed. In this way, for example, a user can take action in such a way that the user refrains from using the application 10 until an evaluation of the application 10 ends, and the like.

Further, the output unit 2060 may transmit, to the terminal 40 in which the application 10 operates, notification representing an evaluation result of the application 10 instead of or in addition to the notification described above. For example, the notification is displayed on a display apparatus connected to the terminal 40. By viewing the notification, a user of the application 10 can recognize the evaluation result of the application 10.

### Modification Example

The evaluation apparatus 2000 may perform the various evaluations described above of the application 10 in which an abnormality is not detected, instead of performing an evaluation of the application 10 in which an abnormality is detected. For example, in the abnormality detection apparatus 60, instead of performing abnormality detection in which false negative is less likely to occur, detection in which false positive is less likely to occur is performed. In this way, the application 10 determined to be abnormal in the abnormality detection apparatus 60 is certainly considered to be abnormal, whereas the application 10 determined to be normal in the abnormality detection apparatus 60 also has a possibility of being abnormal.

Thus, in such a case, an evaluation of the application 10 determined to be normal in the abnormality detection apparatus 60 (the application 10 in which an abnormality is not detected) is performed by the evaluation apparatus 2000, and thus whether the application 10 is really normal, a normality degree of the application 10, and the like can be recognized. In other words, an evaluation whether the application 10 is normal or abnormal can be achieved with higher accuracy.

### Example Embodiment 2

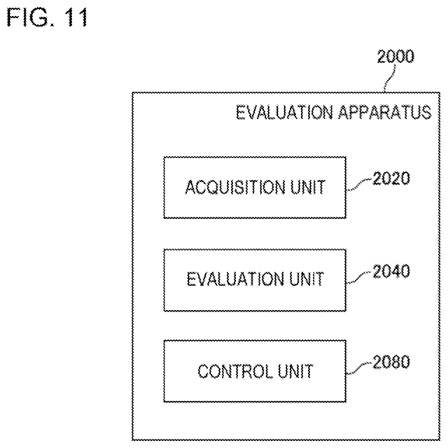

FIG. 11 is a block diagram illustrating a functional configuration of an evaluation apparatus 2000 according to an example embodiment 2. The evaluation apparatus 2000 according to the example embodiment 2 has a function similar to that of the evaluation apparatus 2000 according to the example embodiment 1 except for a point described below.

The evaluation apparatus 2000 according to the example embodiment 2 includes a control unit 2080. The control unit 2080 performs control on an application 10, based on a result of an evaluation by an evaluation unit 2040. For example, the control unit 2080 stops execution of the application 10 evaluated to be abnormal. In addition, for example, the control unit 2080 prevents the application 10 evaluated to be abnormal from accessing another object (such as a process, a file, and a socket). Note that, an object that limits access may be only a part of objects. In addition, for example, the control unit 2080 may intercept a message transmitted from the application 10 evaluated to be abnormal to the outside.

For example, the control unit 2080 controls the application 10 by transmitting a predetermined request to the agent application described above. The agent application is configured in such a way as to be able to output, to an OS and middleware, an instruction that stops execution of a specified application, and output, to an OS and middleware, an instruction that limits access to another object from a specified application. The control unit 2080 transmits a request indicating a combination of “identification information about the application 10, and a control content” to the agent application. The agent application transmits, to an OS and the like, an instruction for the application 10 specified by the request in such a way as to achieve a control content indicated by the request. In this way, an operation of the application 10 is controlled according to an instruction by the control unit 2080.

Herein, a content of control on the application 10 may be determined based on a normality degree or an abnormality degree of the application 10. For example, a content of each different control is associated in advance with a plurality of numerical ranges of an evaluation value computed by the evaluation unit 2040. In this way, a content of control applied to the application 10 can be changed in response to a level of an abnormality degree of the application 10.

For example, a domain of an abnormality degree is divided in advance into three ranges of a first range (abnormality degree>=Th1) representing that the abnormality degree is extremely high, a second range (Th1>abnormality degree>=Th2) representing that the abnormality degree is medium, and a third range (abnormality degree<Th 2) representing that the abnormality degree is low. Herein, Th1 and Th2 are real numbers that satisfy Th1>Th2. Then, control being “stop of an application” is associated in advance with the first range, control being “interception of access to another object” is associated in advance with the second range, and “no control” is associated in advance with the third range. In this way, the control unit 2080 can achieve control in such a way as to stop, for the application 10 (i.e., the application 10 having an extremely high abnormality degree) having an evaluation value included in the first range, execution of the application 10, to intercept, for the application 10 (i.e., the application 10 having a medium abnormality degree) having an evaluation value included in the second range, access to another object without stopping execution of the application 10, and not to limit, for the application 10 (i.e., the application 10 having a low abnormality degree) having an abnormality degree included in the third range, an operation of the application 10. In other words, an operation of the application 10 can be flexibly controlled in response to a level of an abnormality degree.

When control by the control unit 2080 is performed, an output unit 2060 may make notification related to the control performed on the application 10 to a terminal 40 in which the application 10 operates. For example, it is assumed that the control unit 2080 stops execution of the application 10. In this case, the output unit 2060 outputs notification representing that the execution of the application 10 is stopped based on a result of an evaluation by an evaluation apparatus 2000. For example, the notification is displayed on a display apparatus connected to the terminal 40. By viewing the notification, a user of the application 10 can recognize that the application 10 is stopped as a result of control by the evaluation apparatus 2000 instead of the application 10 being stopped due to an unexpected situation such as a malfunction in the terminal 40. Thus, stopping the application 10 can be prevented from making a user confused.

In addition, for example, it is assumed that the control unit 2080 limits an operation of the application 10. In this case, the output unit 2060 outputs notification representing that the operation of the application 10 is limited based on a result of an evaluation by the evaluation apparatus 2000, and representing a content of the limit. For example, the notification is displayed on a display apparatus connected to the terminal 40. By viewing the notification, a user of the application 10 can recognize that an operation of the application 10 is limited as a result of control by the evaluation apparatus 2000 instead of the application 10 stopping to normally operate due to an unexpected situation such as a malfunction in the terminal 40. Thus, limiting an operation of the application 10 can be prevented from making a user confused.

### Example of Hardware Configuration

For example, a hardware configuration of the evaluation apparatus 2000 according to the example embodiment 2 is represented in FIG. 3 similarly to the hardware configuration of the evaluation apparatus 2000 according to the example embodiment 1. However, a program module that achieves a function of the evaluation apparatus 2000 according to the example embodiment 2 is stored in a storage device 1080 of the evaluation apparatus 2000 according to the example embodiment 2.

### Flow of Processing

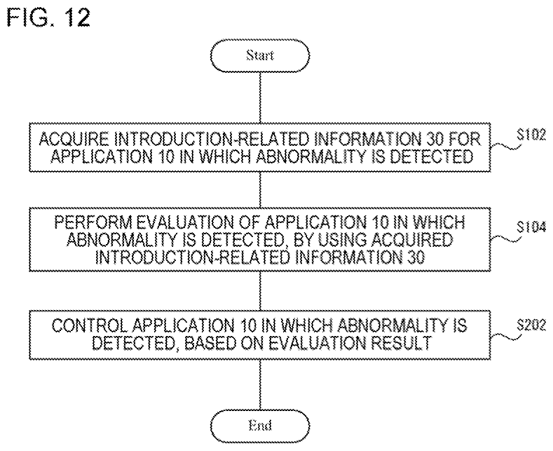

FIG. 12 is a flowchart illustrating a flow of processing executed by the evaluation apparatus 2000 according to the example embodiment 2. After performing S102 to S104, the control unit 2080 performs control on the application 10, based on an evaluation result.

### Modification Example

The control on the application 10 described above may be performed in response to an input operation by an IT administrator and the like (hereinafter, an IT administrator and the like) who perform monitoring and the like of a target system 20 by using the evaluation apparatus 2000 instead of being automatically performed by the evaluation apparatus 2000. In this case, the output unit 2060 outputs output information (for example, the evaluation result screen in FIG. 10) representing an evaluation result.

An IT administrator and the like refer to the output information, and select the application 10 whose operation is desired to be controlled, and a content of control to be performed on the application 10. The evaluation apparatus 2000 transmits, to agent software, a request indicating a combination of “identification information about the application 10 selected by a user, and a content of control selected by the application 10”. Then, the agent software controls the application 10 in response to the received request.

Further, the evaluation apparatus 2000 may be configured in such a way as to perform both of automatic control based on an evaluation result and manual control by an IT administrator and the like. For example, when an abnormality degree is sufficiently high or an abnormality degree is sufficiently low, the automatic control by the evaluation apparatus 2000 is performed, and, when an abnormality degree is medium, the manual control by an IT administrator and the like is performed. More specifically, “stop of an application”, “selection of control by a user”, and “no control” are associated in advance with the first range, the second range, and the third range of an abnormality degree in the example described above, respectively. In this way, control on the application 10 can be automatically performed when an abnormality degree of the application 10 is high or low, whereas determination of a method of controlling the application 10 can be transferred to an IT administrator and the like in a delicate situation where it cannot be said that an abnormality degree of the application 10 is high or low. Thus, accurate control on the application 10 can be achieved while reducing a working burden on a user.

While the example embodiments of the present invention have been described with reference to the drawings, the example embodiments are only exemplification of the present invention, and various configurations other than the above-described example embodiments can also be employed.

The whole or part of the example embodiments described above can be described as, but not limited to, the following supplementary notes.
1. An evaluation apparatus, including:

an acquisition unit that acquires, for an application on which processing of detecting an abnormality in an application is performed, introduction-related information related to introduction of the application; and

an evaluation unit that performs an evaluation of the application by using the acquired introduction-related information.
2. The evaluation apparatus according to supplementary note 1, wherein

an abnormality in the application is detected based on behavior of the application.
3. The evaluation apparatus according to supplementary note 1 or 2, wherein

the introduction-related information includes one or more pieces of introduction path information related to an introduction path of the application, arrangement information related to a place where the application is arranged, and setting information related to setting due to introduction of the application.

4. The evaluation apparatus according to supplementary note 3, wherein

the introduction path information includes at least one piece of information about a provision source of the application, information about a downloader used for downloading the application, and information about an installer used for installing the application.
5. The evaluation apparatus according to any one of supplementary notes 1 to 4, wherein

the evaluation unit acquires reference information indicating a reference related to introduction of the application, and performs an evaluation of the application, based on a comparison between the introduction-related information and the reference information.
6. The evaluation apparatus according to supplementary note 5, wherein

the evaluation unit computes an evaluation value representing a normality degree or an abnormality degree of the application, based on a degree of coincidence between the introduction-related information and the reference information.
7. The evaluation apparatus according to any one of supplementary notes 1 to 6, further including

a control unit that performs control on the application, based on a result of an evaluation by the evaluation unit.
8. The evaluation apparatus according to supplementary note 7, wherein

the control unit
performs predetermined control on the application when an abnormality degree of the application is equal to or more than a first threshold value, and
receives, from a user, selection of a content of control on the application and performs control having a content selected by the user on the application, when an abnormality degree of the application is less than a first threshold value.
9. A system, including:

an abnormality detection apparatus and an evaluation apparatus, wherein

the abnormality detection apparatus performs processing of detecting an abnormality in an application, and

the evaluation apparatus includes
an acquisition unit that acquires, for an application on which processing of abnormality detection is performed by the abnormality detection apparatus, introduction-related information related to introduction of the application, and
an evaluation unit that performs an evaluation of the application by using the acquired introduction-related information.
10. The system according to supplementary note 9, wherein

an abnormality in the application is detected based on behavior of the application.
11. The system according to supplementary note 9 or 10, wherein

the introduction-related information includes one or more pieces of introduction path information related to an introduction path of the application, arrangement information related to a place where the application is arranged, and setting information related to setting due to introduction of the application.
12. The system according to supplementary note 11, wherein

the introduction path information includes at least one piece of information about a provision source of the application, information about a downloader used for downloading the application, and information about an installer used for installing the application.
13. The system according to any one of supplementary notes 9 to 12, wherein

the evaluation unit acquires reference information indicating a reference related to introduction of the application, and performs an evaluation of the application, based on a comparison between the introduction-related information and the reference information.
14. The system according to supplementary note 13, wherein

the evaluation unit computes an evaluation value representing a normality degree or an abnormality degree of the application, based on a degree of coincidence between the introduction-related information and the reference information.
15. The system according to any one of supplementary notes 9 to 14, further including

a control unit that performs control on the application, based on a result of an evaluation by the evaluation unit.
16. The system according to supplementary note 15, wherein

the control unit
performs predetermined control on the application when an abnormality degree of the application is equal to or more than a first threshold value, and
receives, from a user, selection of a content of control on the application and performs control having a content selected by the user on the application, when an abnormality degree of the application is less than a first threshold value.
17. A control method executed by a computer, including:

an acquisition step of acquiring, for an application on which processing of detecting an abnormality in an application is performed, introduction-related information related to introduction of the application; and

an evaluation step of performing an evaluation of the application by using the acquired introduction-related information.
18. The control method according to supplementary note 17, further including

detecting an abnormality in the application, based on behavior of the application.
19. The control method according to supplementary note 17 or 18, wherein

the introduction-related information includes one or more pieces of introduction path information related to an introduction path of the application, arrangement information related to a place where the application is arranged, and setting information related to setting due to introduction of the application.
20. The control method according to supplementary note 19, wherein

the introduction path information includes at least one piece of information about a provision source of the application, information about a downloader used for downloading the application, and information about an installer used for installing the application.
21. The control method according to any one of supplementary notes 17 to 20, further including,

in the evaluation step, acquiring reference information indicating a reference related to introduction of the application, and performing an evaluation of the application, based on a comparison between the introduction-related information and the reference information.
22. The control method according to supplementary note 21, further including,

in the evaluation step, computing an evaluation value representing a normality degree or an abnormality degree of the application, based on a degree of coincidence between the introduction-related information and the reference information.
23. The control method according to any one of supplementary notes 17 to 22, further including

a control step of performing control on the application, based on a result of an evaluation by the evaluation step.
24. The control method according to supplementary note 23, further including:

in the control step,
performing predetermined control on the application when an abnormality degree of the application is equal to or more than a first threshold value; and
receiving, from a user, selection of a content of control on the application and performing control having a content selected by the user on the application, when an abnormality degree of the application is less than a first threshold value.
25. A program causing a computer to execute each step of the control method according to any one of supplementary notes 17 to 24.

What is claimed is:

1. An evaluation apparatus, comprising:
an acquisition unit that acquires, for an application on which processing of detecting an abnormality in an application is performed, introduction-related information related to introduction of the application; and
an evaluation unit that performs an evaluation of the application by using the acquired introduction-related information.

2. The evaluation apparatus according to claim 1, wherein
an abnormality in the application is detected based on behavior of the application.

3. The evaluation apparatus according to claim 1, wherein
the introduction-related information includes one or more pieces of introduction path information related to an introduction path of the application, arrangement information related to a place where the application is arranged, and setting information related to setting due to introduction of the application.

4. The evaluation apparatus according to claim 3, wherein
the introduction path information includes at least one piece of information about a provision source of the application, information about a downloader used for downloading the application, and information about an installer used for installing the application.

5. The evaluation apparatus according to claim 1, wherein
the evaluation unit acquires reference information indicating a reference related to introduction of the application, and performs an evaluation of the application, based on a comparison between the introduction-related information and the reference information.

6. The evaluation apparatus according to claim 5, wherein
the evaluation unit computes an evaluation value representing a normality degree or an abnormality degree of the application, based on a degree of coincidence between the introduction-related information and the reference information.

7. The evaluation apparatus according to claim 1, further comprising
a control unit that performs control on the application, based on a result of an evaluation by the evaluation unit.

8. The evaluation apparatus according to claim 7, wherein
the control unit
performs predetermined control on the application when an abnormality degree of the application is equal to or more than a first threshold value, and
receives an input of selecting a content of control on the application and performs control having the selected content on the application, when an abnormality degree of the application is less than a first threshold value.

9. A system, comprising:
an abnormality detection apparatus and an evaluation apparatus, wherein
the abnormality detection apparatus performs processing of detecting an abnormality in an application, and
the evaluation apparatus includes
an acquisition unit that acquires, for an application on which processing of abnormality detection is performed by the abnormality detection apparatus, introduction-related information related to introduction of the application, and
an evaluation unit that performs an evaluation of the application by using the acquired introduction-related information.

10. The system according to claim 9, wherein
an abnormality in the application is detected based on behavior of the application.

11. The system according to claim 9, wherein
the introduction-related information includes one or more pieces of introduction path information related to an introduction path of the application, arrangement information related to a place where the application is arranged, and setting information related to setting due to introduction of the application.

12. The system according to claim 11, wherein
the introduction path information includes at least one piece of information about a provision source of the application, information about a downloader used for downloading the application, and information about an installer used for installing the application.

13. The system according to claim 9, wherein
the evaluation unit acquires reference information indicating a reference related to introduction of the application, and performs an evaluation of the application, based on a comparison between the introduction-related information and the reference information.

14. The system according to claim 13, wherein
the evaluation unit computes an evaluation value representing a normality degree or an abnormality degree of the application, based on a degree of coincidence between the introduction-related information and the reference information.

15. The system according to claim 9, further comprising
a control unit that performs control on the application, based on a result of an evaluation by the evaluation unit.

16. The system according to claim 15, wherein
the control unit
performs predetermined control on the application when an abnormality degree of the application is equal to or more than a first threshold value, and
receives an input of selecting a content of control on the application and performs control having the selected content on the application, when an abnormality degree of the application is less than a first threshold value.

17. A control method executed by a computer, comprising:
an acquisition step of acquiring, for an application on which processing of detecting an abnormality in an application is performed, introduction-related information related to introduction of the application; and
an evaluation step of performing an evaluation of the application by using the acquired introduction-related information.

18. The control method according to claim 17, further comprising
detecting an abnormality in the application, based on behavior of the application.

19. The control method according to claim 17, wherein
the introduction-related information includes one or more pieces of introduction path information related to an introduction path of the application, arrangement information related to a place where the application is arranged, and setting information related to setting due to introduction of the application.

20. The control method according to claim 19, wherein
the introduction path information includes at least one piece of information about a provision source of the application, information about a downloader used for downloading the application, and information about an installer used for installing the application.

21. The control method according to claim 17, further comprising,
in the evaluation step, acquiring reference information indicating a reference related to introduction of the application, and performing an evaluation of the application, based on a comparison between the introduction-related information and the reference information.

22. The control method according to claim 21, further comprising,
in the evaluation step, computing an evaluation value representing a normality degree or an abnormality degree of the application, based on a degree of coincidence between the introduction-related information and the reference information.

23. The control method according to claim 17, further comprising
a control step of performing control on the application, based on a result of an evaluation by the evaluation step.

24. The control method according to claim 23, further comprising:
in the control step,
performing predetermined control on the application when an abnormality degree of the application is equal to or more than a first threshold value; and
receiving an input of selecting a content of control on the application and performing control having the selected content on the application, when an abnormality degree of the application is less than a first threshold value.

25. A non-transitory computer readable medium having recorded thereon a program causing a computer to execute each step of the control method according to claim 17.
